(19) United States
(12) Patent Application Publication
(10) Pub. No.: US 2026/0337410 A1
(43) Pub. Date: Oct. 29, 2026

(54) IN-SITU FOAM BASED ON POLYLYSINE

(71) Applicant: BASF SE, Ludwigshafen am Rhein (DE)

(72) Inventors: Frank REUTER, Ludwigshafen am Rhein (DE); Johannes AHRENS, Ludwigshafen am Rhein (DE); Alexander KOENIG, Ludwigshafen am Rhein (DE); David TUERP, Ludwigshafen am Rhein (DE); Gereon Antonius SOMMER, Ludwigshafen am Rhein (DE)

(21) Appl. No.: 19/117,743

(22) PCT Filed: Sep. 28, 2023
(86) PCT No.: PCT/EP2023/076912

§ 371 Date: Apr. 2, 2025

(30) Foreign Application Priority Data
Oct. 5, 2022 (EP) 22199814.9

(51) Int. Cl. C08L 77/04; C08J 9/00; C08J 9/30; C08K 5/41

(52) U.S. Cl. CPC C08L 77/04; C08J 9/0033; C08J 9/0061; C08J 9/30; C08K 5/41; C08J 2377/04; C08J 2405/00; C08J 2439/02; C08L 2201/02; C08L 2203/14; C08L 2205/03

(57) ABSTRACT

The present invention relates to a system for producing an in-situ foam, comprising one or more poly(amino acid) (A), one or more components (B) capable of reacting with said poly(amino acid) (A) and one or more amphoteric polymers (C), wherein component (B) is selected from reducing sugars, 1,3-dihydroxyacetone, glycolaldehyde, glyceraldehyde or any mixture thereof and a process for producing the in-situ foam.

The present invention relates to a system for producing an in-situ foam, comprising one or more poly(amino acid) (A), one or more components (B) capable of reacting with said poly(amino acid) (A) and one or more amphoteric polymer(s) (C), wherein component (B) is selected from reducing sugars, 1,3-dihydroxyacetone, glycolaldehyde, glyceraldehyde or any mixture thereof and a process for producing the in-situ foam.

### RELEVANT PRIOR ART

Reactive, non-thermoplastic (thermoset) polymer foams are used for many applications, e.g., thermal insulation, acoustic absorption, cushioning, cleaning, packaging and many more. In most cases, these reactive, non-thermoplastic foams are produced by the usage of suited blowing agents, e. g hexane, pentane, butane or its isomers or fluorocarbon hydrates or others. For the case that the polymer reaction is not exothermic enough, the foams have to be exposed to heat to enable the evaporation of the blowing agent. This is realized by hot molds, hot air or the use of microwave technologies. In most cases, high amounts of heat must be applied because of the heat insulating effect during the foam expansion. Furthermore, a high safety effort has to be ensured for a safe transport, storage, processing and disposal of the flammable blowing agents. One example is EP 0 031 513 A2 that describes the preparation of an elastic, open-celled foam based on urea-formaldehyde with blowing agent pentane.

Another possibility is the use of gases, e. g. CO₂, to enable the foaming of reactive, non-thermoplastic polymer foams. In this case, high pressure drops are necessary to enable the formation of foams. This can only be realized by cost-intensive pressure-resistant equipment in the foam production.

Flexible polyurethane foams can be foamed by the use of water. The water reacts with isocyanate group of the respective isocyanate (e. g. TDI or MDI) to the disubstituted urea and CO₂. The CO₂ acts as intrinsic blowing agent in the foam formation. The final foams show a high flexibility and good acoustic absorption. But the use of isocyanates causes high safety efforts for a safe transport, storage, processing, and disposal.

To overcome the mentioned drawbacks open-celled, water-based, air-blown foams can be used.

One example of air-blown foam is described in WO 2017/067792. A mixture of >50% inorganic filler, cationic or amphoteric polymer, a crosslinking agent, surfactants, and other additives are mixed with air and cured to create air-blown foams with densities from 10 to 50 kg/m³. The resulting foams show good thermal insulation values (~35 mW/m*K) and a low calorific value with less than 3.0 MJ/kg. The most important application of these foams is the thermal insulation of cavities in constructions. On the other side, these rigid foams are highly brittle and show a certain degree of shrinkage (>5%) (free standing foam-no mold).

Another example is a foam based on urea-formaldehyde condensates described in U.S. Pat. No. 2,789,095. A mixture of urea-formaldehyde condensate with suitable curing agents, surfactants and other additives are mixed with air and cured to create air-blown foams with densities from 12 to 15 kg/m³. The resulting foams show good thermal insulation values (~35 mW/m*K) and good fire retardancy behavior [construction class B2 (DIN 4102)]. On the other side, these rigid foams are brittle and can show high amounts of formaldehyde emissions.

WO 2016/009062 and WO 2011/138458 disclose a binder comprising the reaction product of a carbohydrate reactant and polyamine useful for consolidating loosely assembled matter, such as fibers. Foams using the binder are not disclosed.

WO 2022/136613 discloses a binder composition comprising polylysine having a total weight average molecular weight Mw of at least 800 g/mol as component A and 1,3-dihydroxyacetone, glycolaldehyde, glyceraldehyde or mixtures thereof as component B and use for manufacturing lignocellulosic composite articles. Foams using the binder are not disclosed.

WO 2022/136614 relates to a binder composition comprising polyamines and hydroxyacetone for composite articles. Foams using the binder composition are not disclosed.

US 2011/0257284 A1 describes a process for producing flame-retardant polyurethane foams. using hyperbranched, nitrogen-containing polymers, in particular hyperbranched polylysines, hyperbranched polyisocyanurates, and hyperbranched polyesteramides for providing flame retardancy to polyurethane foams.

### SUMMARY OF THE INVENTION

The present invention was made in view of the prior art described above, and the object of the present invention is to provide an open-celled, formaldehyde- and isocyanate-free flexible foam with good acoustic absorption which can be obtained from bio- and water-based raw materials and processed in situ as air-blown foam.

### Technical Problem Solved

This object was solved by a foam and a system for producing an in-situ foam, comprising one or more poly(amino acid) (A), one or more components (B) capable of reacting with said poly(amino acid) (A) and one or more amphoteric polymers (C), wherein component (B) is selected from reducing sugars, 1,3-dihydroxyacetone, glycolaldehyde, glyceraldehyde or any mixture thereof.

Preferably the foam is not a polyurethane foam. Preferably the foaming mixture does not contain isocyanates and/or polyols. Preferably the foaming mixture comprises more than 50 wt.-%, more preferably more than 70 wt.-% of the poly(amino acid) (A) based on the solids of the sum of the reactive components (A) and (B).

Preferably the process comprises foaming a mixture, which comprises
1 to 40 wt.-% of one or more poly(amino acid) (A)
1 to 15 wt.-% of one or more components (B) capable of reacting with said poly(amino acid) (A)
1 to 10 wt.-% of one or more amphoteric polymers (C),
1 to 15 wt.-% of one or more surfactants (D),
1 to 90 wt.-% of water (E),
0 to 90 wt.-% of one or more additional additives (F),
wherein the sum of the weight percentages of said components (A) to (F) is 100 wt.-%.

More preferably the process comprises foaming a mixture, which comprises
10 to 20 wt.-% of one or more poly(amino acid) (A)
2 to 8 wt.-% of one or more components (B) capable of reacting with said poly(amino acid) (A)
1 to 3 wt.-% of one or more amphoteric polymers (C),
3 to 12 wt.-% of one or more surfactants (D),
50 to 80 wt.-% of water (E),
0 to 34 wt.-% of one or more additional additives (F),
wherein the sum of the weight percentages of said components A) to F) is 100 wt.-%.

More preferably the process comprises foaming a mixture which essentially consist of the components (A) to (E) in the above-mentioned amounts.

Most preferably the process comprises foaming a mixture, which consist of
10 to 20 wt.-% of one or more poly(amino acid) (A)
2 to 8 wt.-% of one or more components (B) capable of reacting with said poly(amino acid) (A)
1 to 3 wt.-% of one or more amphoteric polymers (C),
3 to 12 wt.-% of one or more surfactants (D),
57 to 80 wt.-% of water (E),
wherein the sum of the weight percentages of said components A) to E) is 100 wt.-%.

### Component (A)

As component (A) poly(amino acid)s e.g., synthetic poly(amino acid)s, natural poly(amino acid)s, polypeptides, proteins, or mixtures thereof are used. Poly(amino acid)s are produced by polymerization of amino acids. Poly(amino acid)s can be obtained by chemical synthesis or by biosynthesis in living organisms. In particular, proteins may be obtained by biosynthesis in living organisms. Polypeptides may be obtained by hydrolysis of proteins.

According to this invention the term poly(amino acid)s may also include poly(amino acid) derivatives, which may be obtained by modification of the poly(amino acid) after polymer synthesis.

Preferred amino acids which are used for the polymerization reaction are diamino acids comprising two amine groups (—NH₂) and at least one carboxyl (—COOH) functional group. Such diamino acids may be ornithine, diaminopimelic acid, 2,3-diaminopropionic acid, 2,4-diaminobutyric acid, and/or lysine, preferably lysine, more preferably L-lysine. Although they are sometimes named as diamino acids, according to this invention asparagine and glutamine are not included in the group of diamino acids, since the second functional group is an amide (CO—NH₂) and not an amine (—NH₂).

Preferably polylysine is used as poly(amino acid). Polylysine may be produced by the polymerization of lysine. Lysine itself is produced by the fermentation of corn starch in presence of suited bacteria. The production of polylysine is generally known and may be performed as e.g., described in WO2016062578 or from lysine salts as described in WO2007060119. A preferred process for producing polylysine is described in WO 2022/136613.

Preferably, component (A) comprise(s) at least one polylysine or consist(s) of one or more polylysine(s), which is (are) a polymerization product of monomer lysine, preferably L-lysine, and optionally other monomers selected from the group consisting of
a) amino acids, preferably comprising at least two amino groups,
b) amines comprising at least two amino groups, wherein the amines are no amino acids, and
c) di and/or tricarboxylic acids, which are preferably no amino acids,
wherein at least 50 wt.-%, preferably at least 75 wt.-%, most preferably 100 wt.-% lysine, is used as monomer for the polymerization reaction based on total amount of monomers.

Preferably the poly(amino acid) (A) has a weight average molecular weight Mw in the range from 800 to 20,000 g/mol, more preferably in the range from 1,500 to 8,000 g/mol. Weight-average molecular weights are determined by size exclusion chromatography (SEC) on hydroxylated polymethacrylate with 0.1% (w/w) trifluoroacetate as solvent and 0.1 M NaCl in distilled water as eluent and calibration with poly(2-vinylpyridine) standards. Most preferably polylysine in aqueous formulation with a molecular weight from 800 to 8,000 g/mol is used as component (A).

### Component (B)

One or more components (B) capable of reacting with said poly(amino acid) (A) selected from reducing sugars, 1,3-dihydroxyacetone, glycolaldehyde, glyceraldehyde or any mixture thereof are used in the foaming mixture. Preferably hydroxy acetone or 1,3-dihydroxyacetone is used as component (B).

Preferably the weight ratio of poly(amino acid) (A) to component (B) is in the range from 2:1 to 5:1.

Poly(amino acid) and reducing sugars from natural sources can be used as raw materials to produce an essentially bio-based foams.

It is assumed that component A and B undergoes Maillard reaction. The first step is the addition of a free amine group of a (poly)amino acid (component (A)) to the carbonyl group of a reducing sugar (ketose/aldose) (component (B)). The formed glycosylamine is unstable and undergoes a Heyns/Amadori rearrangement to the Heyns/Amadori compound (aldosamine/ketosamine) with loss of one water molecule.

In the case of the reaction of polylysine with (di)hydroxyacetone, a crosslinked thermoset brown solid material is formed.

### Component (C)

Amphoteric polymers suitable as component (C) are for example described in WO 2004/087818 and WO 2005/012637. Preference is given to copolymers comprising units derived from vinylamine and vinylformamide or from vinylamine and unsaturated carboxylic acids/carboxylic acid salts and terpolymers comprising units derived from vinylamine, vinylformamide and unsaturated carboxylic acids/carboxylic acid salts. Particular preference is given to copolymers formed from vinylamine and sodium acrylate and terpolymers formed from vinylamine, vinylformamide and sodium acrylate. XELOREX® F 3000 may be mentioned by way of example.

### Component (D)

Component (D) of the system comprises one or more surfactants used to form and stabilize the foam. Anionic, cationic, nonionic, or amphoteric surfactants are usable.

Suitable anionic surfactants are diphenylene oxide sulfonates, alkane- and alkylbenzenesulfonates, alkylnaphthalenesulfonates, olefinsulfonates, alkyl ether sulfonates, alkyl sulfates, alkyl ether sulfates, alpha-sulfofatty acid esters, acylaminoalkanesulfonates, acylisethionates, alkyl ether carboxylates, N-acylsarcosinates, alkyl and alkyl ether phosphates.

Useful nonionic surfactants include alkylphenol polyglycol ethers, fatty alcohol polyglycol ethers, fatty acid polyglycol ethers, fatty acid alkanolamides, EO-PO block copolymers, amine oxides, glyceryl fatty acid esters, sorbitan esters and alkylpolyglucosides. Useful cationic surfactants include alkyltriammonium salts, alkylbenzyldimethylammonium salts and alkylpyridinium salts.

Mixtures of anionic and nonionic surfactants are employed with particular preference.

Preferably a mixture of an anionic and a non-ionic surfactant is used as surfactant (D). More preferably a mixture of the sodium salt of a (C12-14) fatty alcohol ether sulfate, a (C12-C14)alkyl polyglycoside or mixture therefrom are used as surfactants (D).

Preferably the weight ratio of anionic surfactant to non-ionic surfactant is in the range from 50:50 to 90:10.

### Component (E)

Water is used as Component (E). Preferably components (A), (B), (C), and (D) are used as aqueous solutions or dispersions. Further water may be added to achieve the above-described composition of the mixture and to adjust viscosity.

### Component (F)

Flame-retardants, fillers and salts, such as Na-formate, Na-acetate, Na-citrate, Na-chloride may be used as further components (F). Preferably, a flame retardant is used as additive (F).

Subject of the invention is also a process for producing an in-situ foam by preparing an aqueous solution or dispersion of the components (A) to (F) of the system described above and foaming the aqueous solution or dispersion with a gas or gas mixture.

The in-situ foam is obtainable by mixing and foaming an aqueous composition comprising components (A) to (F) with a gas or gas mixture under (super)atmospheric pressure and applying mechanical forces, such as stirring or shearing by means of static mixers. It is also possible to foam the aqueous composition by dispersing an inert gas in the form of fine bubbles of the gas. The introduction of gas bubbles into the aqueous composition will be effectuated by means of beating, shaking, stirring, whip-stator or rotor devices. Preference is given to using mixers having stator and/or rotor elements.

The gas or gas mixture used preferably comprises inert gases, such as nitrogen, argon, carbon dioxide or oxygen. Air is used with particular preference.

A preferred process comprising the steps of
(a) preparing an aqueous solution or dispersion comprising components (A) to (F),
(b) foaming the aqueous solution or dispersion by introducing a gas or gas mixture into an aqueous solution or dispersion via one or more mixing elements,
(c) transferring the foam obtained in step (b) into a mold, and
(d) curing and drying the foam at 50 to 160 °C.

Subject to the invention is also a foam obtainable by the process described above. The dried foam preferably comprises more than 50 wt.-%, more preferably more than 65 wt.-% of components (A) and (B) incorporated as reticulates matrix of the foam.

Preferably the foam has a density in the range from 10 to 60 kg/m³, determined according to DIN 53420. The density can by adjusted by the amount of amphoteric polymers (component (C)) and surfactants (component (D)). Density may be increased by using more of the reactive components (A) and (B) in the system for producing the in-situ foam.

Preferably the foam has a shore hardness 000 in the range from 20 to 80, determined according to ASTM D 2240.

The resulting air-blown foam shows a high flexibility (Shore Hardness) and good sound absorption properties.

The foam according to the invention is
obtainable by an air-blown foaming process
free of formaldehyde and isocyanate
open celled, with an open-cell content of more than 95%, determined by light microscopy
water-based
is not brittle and shows a high flexibility as evidenced by a low shore hardness value
has good acoustical absorption properties over a wide frequency range and low air flow resistance.

### EXAMPLES

Hereinafter, the present invention is described in more detail and specifically with reference to the examples, which however are not intended to limit the present invention.

### Raw Materials Used:

Surfactant 1: anionic surfactant Disponil® FES 32 (31 wt.-% in water, fatty alcohol (C12-C14) ether (~4 EO) sulfate sodium salt, BASF SE);
Surfactant 2: non-ionic surfactant, Glucopon® GD 70 (68 wt.-% in water, C10-C12-alkyl polyglucoside);
Water: de-ionized water;
Polylysine-1: having a weight average molecular weight Mw of about 2,000 g/mol (50 wt. % in water).
Polylysine-5: having a weight average molecular weight Mw of about 5,500 g/mol (50 wt. % in water);
Polylysine-1 and polylysine-5 were prepared according to Example 1 of WO 2022/136613 by thermal treatment of L-lysine
Amphoteric polyvinylamine Xelorex® F3000 (11 wt.-% in water NVF/VA/AA copolymer (35/35/30 mol %)), Solenis-BASF;
Crosslinker: 1,3-Dihydroxyacetone (70 wt.-% in water, Sigma-Aldrich).

### Determination of the Weight-Average Molecular Weight M_{w} of Polylysine

M_{w} was determined by size exclusion chromatography under the following conditions:
Solvent and eluent: 0.1% (w/w) trifluoroacetate, 0.1 M NaCl in distilled water
Flow: 0.8 ml/min
Injection volume: 100 μl
Samples are filtrated with a Sartorius Minisart RC 25 (0.2 μm) filter
Column material: hydroxylated polymethacrylate (TSKgel G3000PWXL)
Column size: inside diameter 7.8 mm, length 30 cm
Column temperature: 35 °C
Detector: DRI Agilent 1100 UV GAT-LCD 503 [232 nm]
Calibration with poly(2-vinylpyridine) standards in the molar mass range from 620 to 2890000 g/mole (from PSS, Mainz, Germany) and pyridine (79 g/mol)
The upper integration limit was set to 29.01 mL
The calculation of M_{w} includes the lysine oligomers and polymers as well as the monomer lysine.

### Characterization of the Foams

The foam density is determined according to DIN 53420.

Shore hardness was measured according to ASTM D 2240. For the measurement of low-density foams, the scale of 000 was used (2.4 mm diameter of the sphere, spring force 1.111 N).

Acoustic absorption was determined by impedance tube measurements according to ISO 10534-2, 30 mm thickness of the sample, 100 mm diameter.

Compression stress value (compression load deflection) CV 40 was measured according to DIN EN ISO 3386-1.

### Examples 1-12: Preparation of Air-Blown Polylysine Based Foams

To a mixture of surfactant 1 and surfactant 2 in water, the aqueous dispersions of polylysine and eventually of amphoteric polyvinylamine are added and mixed by gently manual shaking for few seconds. Then, the crosslinker in water is added and the whole mixture is treated with a high-shear mixer (Krups Handmixer 3Mix7000) at high velocity for 1 min. Thereby, a fine-celled air-blown foam with an open-cell content of more than 95% determined by light microscopy is produced, which is poured into suitable molds (e.g., box of 10×10×5 cm). The liquid foam is cured and dried at 100 °C for 24 h. After cooling, the now solid foam is demolded.

Composition (in parts per weight) and shore hardness 000 (23 °C, 50% rel. humidity) of the foams obtained are shown in Table 1. The foam density of the samples of examples 1-9 after conditioning for 24 h at 50% r. h. were determined to be in the range from 24-28 kg/m³.

The obtained foam has an open-celled structure (>95% open cells as determined by optical microscopy) and it exhibits a good sound absorption in the frequency range of 100-5.000 Hz with maximum absorption around 2.000 Hz similar to common open-celled PUR soft foams. Sound absorption of the foam obtained from Example 1 is shown in Table 2.

Mechanical properties after temperature and moisture conditioning at 23 °C, 50% relative humidity are shown in Table 3. At higher tempering temperatures the foam shows a higher shore hardness and compression load. Conditioning at higher relative humidity results in softer foams.

With no crosslinker (example 11), with polylysine of low molecular weight (example 12) or without stabilizing prepolymer polyvinylamine (example 10), less homogenous foam can be achieved after curing.

TABLE 1
Composition and shore hardness of the foams obtained

| | Example | | | | | | | | | | | |
|---|---|---|---|---|---|---|---|---|---|---|---|---|
| | 1 | 2 | 3 | 4 | 5 | 6 | 7 | 8 | 9 | 10 | 11 | 12 |
| Surfactant 1 [g] | 11.2 | 9.3 | 7.5 | 5.6 | 11.2 | 11.2 | 11.2 | 11.2 | 11.2 | 11.2 | 11.2 | 11.2 |
| Surfactant 2 [g] | 2.1 | 1.8 | 1.4 | 1.1 | 2.1 | 2.1 | 2.1 | 2.1 | 2.1 | 2.1 | 2.1 | 2.1 |
| Water [g] | 26.7 | 28.9 | 31.1 | 33.3 | 26.7 | 26.7 | 26.7 | 26.7 | 26.7 | 26.7 | 26.7 | 26.7 |
| Polylysine-5 [g] | 22.1 | 22.1 | 22.1 | 22.1 | 22.1 | 22.1 | 22.1 | 22.1 | 22.1 | 22.1 | 22.1 | — |
| Polylysine-1 [g] | — | — | — | — | — | — | — | — | — | — | — | 22.1 |
| Amphoteric | 8 | 8 | 8 | 8 | 8 | 8 | 8 | 6 | 4 | 0 | 8 | 8 |
| polyvinylamine [g] | | | | | | | | | | | | |
| Crosslinker [g] | 5.6 | 5.6 | 5.6 | 5.6 | 6.3 | 6.8 | 7.9 | 5.6 | 5.6 | 5.6 | 0 | 5.6 |
| Homogenous foam | Yes | Yes | Yes | Yes | Yes | Yes | Yes | Yes | Yes | No | No | No |
| Shore hardness | 54 | 58 | 60 | — | 63 | 68 | 67 | 64 | 66 | — | — | — |
| 000, 23 °C, 50% | | | | | | | | | | | | |
| r.h. | | | | | | | | | | | | |

TABLE 2
Sound absorption of the foam of Example 1:

| Frequency [Hz] | Absorption |
|---|---|
| 160 | 0.067 |
| 200 | 0.089 |
| 250 | 0.116 |
| 315 | 0.133 |
| 400 | 0.177 |
| 500 | 0.221 |
| 630 | 0.256 |
| 800 | 0.376 |
| 1000 | 0.536 |
| 1250 | 0.655 |
| 1600 | 0.779 |
| 2000 | 0.968 |
| 2500 | 0.960 |
| 3150 | 0.857 |

TABLE 3
Mechanical properties after temperature
and moisture conditioning of example 1

| | | Compression | Shore |
|---|---|---|---|
| Tempering | Conditioning | load deflection | hardness |
| (24 h) | (72 h) | (CV 40)/kPa | (000) |
| 100 °C | 23 °C, 50% r.h. | 15.3 | 40 |
| 120 °C | 23 °C, 50% r.h. | 15.8 | 41 |
| 140 °C | 23 °C, 50% r.h. | 24.1 | 55 |
| 160 °C | 23 °C, 50% r.h. | 34.4 | 72 |
| 100 °C | 23 °C, 80% r.h. | 1.9 | <5 |
| 120 °C | 23 °C, 80% r.h. | 2.7 | <5 |
| 140 °C | 23 °C, 80% r.h. | 2.9 | <10 |
| 160 °C | 23 °C, 80% r.h. | 3.2 | <10 |

### Comparative Example C1

To a mixture of surfactant 1, Disponil® FES 32 (2.4 g, 31%), and surfactant 2, Glucopon® GD 70 (0.5 g, 68%), in water (22.1 g), the crosslinker glyoxal in water (1 g, 2%) is added and mixed by gently shaking for few seconds. The mixture is treated with a high-shear mixer at high velocity for 1 min. Thereby, a fine-celled air-blown foam is produced. The aqueous dispersion of amphoteric polyvinylamine Xelorex® F3000 (25 g, 11%) is carefully added to the foam and homogenized quickly. The mixture is poured into a mold of a box of 10×10×5 cm. The liquid foam is cured and dried at 50 °C for 24 h. A foam density of 32 kg/m³ was obtained. After cooling, the now solid foam is demolded.

The demolded, free-standing, soft foam of example C1 was collapsing at 23 °C/50% r.h. with a volume shrinkage 0% after 30 min, 10% after 120 min, 18% after 210 min, 24% after 330 min, and 47% after 3 d. The demolded, free-standing, flexible foam of example 1 was stable under these conditions with no dimensional changes.

### Comparative Example C2

Air-Blown Foam Made from Urea-Formaldehyde Resin

Component A is made of 25 g of a water-soluble urea-formaldehyde precondensate (Basopor® 293 powder) mixed with 41 g of water by stirring. When dissolved, 3 g urea is added and stirred for at least 1 h. After standing for 12 h, 15 g water is mixed in. Component B is produced from a mixture of 4.7 mL of a foaming agent (Basomol® 514 liquid) (aqueous solution comprising 25% H3PO4 (85%), 4% resorcin, 20% dibunate sodium; having a pH of 1-2) and 100 mL water by stirring for 30 min. 25 g of component B is treated with a high-shear mixer at high velocity for 1 min. Thereby, a fine-celled air-blown foam is produced. 47 g of component A is carefully added to the foam and homogenized quickly. The mixture is poured into a mould of a box of 10×10×5 cm. The liquid foam is cured and dried at 50 °C for 24 h. A foam density of 18.5 kg/m³ was obtained. After cooling, the now solid foam is demolded.

Note: The final density of air-blown foam cannot be adjusted in a wider range as for solvent-blown foam. The foam density is given by the specific foaming agent and the setup of the foaming technique. As the same foaming technique with a high-shear mixer is applied within the shown examples and comparative examples, the resulting foam densities made from polylysine/dihydroxyacetone, polyvinylamine/glyoxal and urea/formaldehyde may differ because of different chemistry, solid content, viscosity, optimized foaming agent.

TABLE 4
Mechanical properties of Example 1 and Comparative Example 2

| | | Comparative |
|---|---|---|
| | Example 1 | Example C2 |
| | (air-blown polylysine/ | (air-blown urea- |
| | dihydroxyacetone foam) | formaldehyde foam) |
| Density | 27.6 kg/m³ | 18.5 kg/m³ |
| Shore hardness (000) | 44 | 81 |
| Compression load | 16.8 kPa (23 °C, | 62.0 kPa (23 °C, 50% |
| deflection (CV 40) | 50% r.h.) 1.7 kPa | r.h. and 80% r.h.) |
| | (23 °C, 80% r.h.) | |

This shows that the polylysine/dihydroxyacetone is a flexible, non-brittle foam. The other air-blown foam based on urea-formaldehyde resin is not flexible.

1.-14. (canceled)

15. A system for producing an in-situ foam, comprising one or more poly(amino acid) (A), one or more components (B) capable of reacting with said poly(amino acid) (A) and one or more amphoteric polymers (C), wherein component (B) is selected from reducing sugars, 1,3-dihydroxyacetone, glycolaldehyde, glyceraldehyde or any mixture thereof.

16. A system according to claim 15 comprising
1 to 40 wt.-% of one or more poly(amino acid) (A);
1 to 15 wt.-% of one or more components (B) capable of reacting with said poly(amino acid) (A);
1 to 10 wt.-% of one or more amphoteric polymers (C);
1 to 15 wt.-% of one or more surfactants (D);
1 to 90 wt.-% of water (E); and
0 to 90 wt.-% of one or more additional additives (F);
wherein the sum of the weight percentages of said components (A) to (F) is 100 wt.-%.

17. The system according to claim 15, wherein the poly(amino acid) (A) is polylysine with a weight average molecular weight Mw in the range from 800 to 20,000 g/mol, determined by size exclusion chromatography (SEC).

18. The system according to claim 15, wherein 1,3-dihydroxyacetone is used as component (B).

19. The system according to claim 15, wherein a terpolymer comprising vinylamine, vinylformamide and sodium acrylate units is used as amphoteric polymer (C).

20. The system according to claim 15, wherein the sodium salt of a (C12-14)-fatty alcohol ether sulfate, a (C12-C14)-alkyl polyglycoside or mixture therefrom are used as surfactants (D).

21. The system according to claim 15, wherein a flame retardant is used as additive (F).

22. The system according to claim 15, wherein the weight ratio of poly(amino acid) (A) to component (B) is in the range from 2.5:1 to 5:1.

23. The system according to claim 15, wherein a mixture of anionic and non-ionic surfactants are used in a weight ratio of anionic surfactant to non-ionic surfactant is in the range from 50:50 to 90:10.

24. A process for producing an in-situ foam by preparing an aqueous solution or dispersion of the components (A) to (F) of the system according to claim 15 and foaming the aqueous solution or dispersion with a gas or gas mixture.

25. The process according to claim 24 comprising the steps of
(a) preparing an aqueous solution or suspension comprising components (A) to (F),
(b) foaming the aqueous solution or suspension by introducing a gas or gas mixture into an aqueous solution or suspension via one or more mixing elements,
(c) transferring the foam obtained in step (b) into a mold, and
(d) curing and drying the foam at 50 to 160 °C.

26. An in-situ foam obtained by the process according to claim 24.

27. The in-situ foam according to claim 26 having a density in the range from 10 to 60 kg/m³, determined according to DIN 53420.

28. The in-situ foam according to claim 26 having a shore hardness in the range from 20 to 80, determined according to ASTM D 2240.
